(19) United States
(12) Patent Application Publication
(10) Pub. No.: US 2021/0129494 A1
(43) Pub. Date: May 6, 2021

(54) LAMINATOR

(71) Applicant: Drew Dudley Goodspeed, Wargrave (GB)

(72) Inventor: Drew Dudley Goodspeed, Wargrave (GB)

(21) Appl. No.: 16/668,346

(22) Filed: Oct. 30, 2019

(51) Int. Cl. B32B 17/10; B26D 1/22; B32B 38/00; B32B 38/10; B32B 37/00

(52) U.S. Cl. CPC B32B 17/10018; B26D 1/225; B32B 38/0004; B32B 2315/08; B32B 17/10807; B32B 37/0046; B32B 38/10

(57) ABSTRACT

A laminator applies a plastics film to an insulated glass unit 6. A conveyor system feeds the insulated glass unit through the laminator in a horizontal orientation and a reel 12 of plastics film is unwound. A perforator 22 having a circular cross section rotates around an axis transverse to a direction of travel of the unwound plastics film 8, and creates a longitudinal line of perforations in the film extending in the direction of travel and at a location outside an edge of the insulated glass unit 6. A laminating roller 2 presses the plastics film 8 against the insulated glass unit 6 to adhere the plastics film thereto, and a transverse cutter 30 creates a transverse line of perforations in the plastics film 8.

### BACKGROUND TO THE INVENTION

This invention relates to a laminator for applying a plastics film to an insulated glass unit (IGU), such as a double or triple glazing unit.

When new IGUs are delivered to a building site they must be clean and undamaged. During the installation process, in order to make a building weatherproof, for the first fix and wet trades, the IGUs are installed. They are then at a high risk of being contaminated by plaster, paint or other building site contaminates, or even scratched in handling.

Many architects are therefore now specifying that IGUs installed in their buildings must be protected with strippable plastic film on both faces. This film is preferably clear (though it is not essential), in order to allow light into the building for the working trades.

The application of pressure sensitive adhesive films of suitable lift expectancy, clarity and UV resistance, is relatively easy whilst the IGU is in the early stages of production without the aluminium or PVC frames attached to the four sides.

A problem arises when the frames are to be attached to the film-covered IGU, as the protective film obstructs the frames on all four edges and on both sides. Therefore a protective film with a clear border, or margin, along all four edges is necessary. Manufacturers will require slightly differing margin widths but they are usually in the range of 1-1.5 inches, although they can be wider or narrower in some circumstances.

Solutions include manually applying the film over the whole surface—resulting in a creased or bubbled application, often with dirt entrapped under the film. Subsequently the border margins are cut with knives, which may mark the glass, soldering irons, or hot knives. The operator then manually removes the margin waste, which now may be stuck more firmly to the glass.

This risks damage to the IGU as well as being a labour-intensive, costly operation. Soldering irons and hot knives can create smoke and fumes which is, at least, unpleasant for the operators, and it is a very slow, manual intensive solution, with the IGU having to be manually turned over. It is also prone to errors.

When looking to create a machine to solve this problem, a further complication arises due, to the very flexible production methods used by IGU makers. The production machines have been evolved to allow “batch of one” production runs in a very efficient manner. Consequently, they often produce consecutive IGUs of varying width and lengths in order to optimise the utilisation of the glass sheets from which the IGU is cut. This trend is reinforced by the client's requirements to have a delivery of all the different sized windows in an area to the building site in the same shipment. Thus inevitably, the manufacturers make the IGUs of many different widths and lengths in any production run.

Whilst the IGU sizes will vary often for each successive unit, any protective film is purchased in roll length of hundreds of yards at pre-set widths.

To resolve these problems some film laminators exist where the film is applied in strips which are narrower than the IGU width. The strips are laid on the IGU surface whilst the IGU is held vertical. Such laminators are made by Cardinal Glass Industries of Galt, Calif., Walco Machines Co of Cucamonga, Calif. and Somerra of Lyon, France.

The IGU is passed through the laminator repeatedly with strips being laid, side by side, until the full face width of the IGU is filmed. If the strips thus applied do not exactly match the width of the IGU, then they will have to be overlaid on top of one other to make the correct width.

With vertical solutions, choosing a wider reel width means less passes, but more waste if an overlay pattern is required. If the narrower width is used then more passes and time is required to apply additional stripes. The wider the reel width the more likely it is for the film reel to be too wide for the next IGU which then will require the film reel to be changed, creating lost production time and increased labour costs.

In summary, this approach takes production time and repeated passes through the laminating head, and requires changing the reel when the IGU is narrower than the film width, as the system cannot trim the excess width from the reel.

Changing film reels is a manual operation and, must be done for the reels on both upper, and lower faces of the IGU. Further, selecting the film widths to have in stock is at best an educated guess and the more choice of film reel widths held, the greater the stock holding costs and space required.

The film reels may be purchased in shorter reel lengths which are lighter and more convenient for handling but then require more frequent changing, as well as the film cost being more expensive, due to extra time and wastage increasing the unit cost of manufacturing the film. For example, extra rewinding and slitting and the higher cost of cardboard cores required, per metre of film supplied, and packaging and handling.

If the reels are too long, depending upon the width, they become too heavy for manual handling, thus requiring cranes and lifting equipment. If the reels are narrow in width order to be applied in strips it avoids some reel changes but necessitates repeated applications to cover the surface. If the reel width selected is too wide the film width has to be changed more frequently.

This scenario requires frequent and continuous “management” decisions, which in many less automated plants, are left to the machine operators, who often have to operate without advance information, as the job batches change frequently and each job batch can be quite small.

### SUMMARY OF THE INVENTION

The present invention provides a laminator for applying a plastics film to an insulated glass unit, comprising a conveyor system for feeding an insulated glass unit through the laminator in a horizontal orientation, a reel of plastics film which is unwound, a perforator having a circular cross section, rotatable around an axis which is transverse to a direction of travel of the unwound plastics film, being arranged to create a longitudinal line of perforations in the film extending in the direction of travel and at a location outside or in line with an edge of the insulated glass unit, a transverse cutter arranged to create a transverse line of perforations in the plastics film; and a laminating roller, located downstream of the perforator and the transverse cutter and arranged to press the plastics film against the insulated glass unit to adhere the plastics film thereto.

There may be a second perforator arranged to create a second longitudinal line of perforations in the plastics film at a location outside or in line with a second edge of the insulated glass unit.

In order to provide a clear border on the IGU without film, third and fourth perforators may be provided to create third and fourth longitudinal lines of perforations in the plastics film at locations inside the edges of the insulated glass unit.

The laminator may be arranged to apply plastics film to both sides of an IGU simultaneously. Thus it may have a second reel of plastics film for the second side, fifth, sixth, seventh and eighth perforators for creating longitudinal lines of perforations in the second plastics film and a second transverse cutter arranged to create a transverse line of perforations in the second plastics film.

The invention also provides a method of adhering a plastics film to an insulated glass unit, the method comprising: conveying an insulated glass unit through a laminator in a horizontal orientation; unwinding plastics film from a reel; rotating a perforator having a circular cross section around an axis transverse to a direction of travel of the unwound plastics film, to create a longitudinal line of perforations in the film, extending in the direction of travel and at a location outside or in line with an edge of the insulated glass unit; operating a transverse cutter to create a transverse cut or line of perforations in the plastics film; and causing a laminating roller to press the plastics film against a face of the insulated glass unit to adhere the plastics film thereto.

### BRIEF DESCRIPTION OF THE DRAWINGS

In the drawings:

FIG. 1 is a simplified side view of a laminator according to an embodiment of the invention, showing the longitudinal perforators;

FIG. 2 is a simplified plan view of the laminator, showing the longitudinal perforators;

FIG. 3 is a simplified side view of the laminator, showing the transverse perforators; and

FIG. 4 is a simplified plan view of the laminator, showing the transverse perforators.

### DETAILED DESCRIPTION OF PARTICULAR EMBODIMENTS

The following detailed description should be read with reference to the drawings. The embodiments shown in the drawings and described below are merely for illustrative purposes, and are not intended to limit the scope of the invention, as defined in the claims.

The laminator consists of a laminating head in the form of a steel and aluminium frame with electric motors and gearboxes (not shown) which drive at least one of an upper rubber nip pressure roller 2 and a lower rubber nip pressure roller 4. These draw an IGU 6 through the laminator whilst applying the necessary pressure to the adhesive film 8, 10 to make it adhere to the IGU. The nip pressure rollers may be set to a pressure value directly using pneumatic or hydraulic cylinders, or the gap may be set using a screw system either manually or electrically adjusted to control the nip pressure indirectly.

The laminator of the invention processes the IGUs 6 horizontally. This approach allows the laminator to film IGUs with surplus film either side, a solution not possible with a vertical orientation. The film width is much wider than the IGU width and surplus film is trimmed from two sides.

Trimming from just one side is possible, but it is advantageous if the filmed width is at least twice as wide as the offcut, to prevent the surplus film from tangling in the machine. This is facilitated by laminating both faces of the IGU at the same time so that the two opposing adhesive faces of the film 8, 10 tend to stick together, rather than to the machine.

Upper and lower film reels 12, 14 are mounted on mandrel shafts 16, 18, These may be either air expanded or mechanically expanded to grip the internal diameter of the cardboard core on which the film is wound. The mandrels are fitted with a tension control brake to maintain the film tension and endure smooth, crease and bubble free application of the film to the glass surfaces.

The passage of the IGU 6 through the laminator is facilitated by conveyor tables comprising solid steel or aluminium frame (not shown) and carrying rollers 20, or wheels or castors, which support the IGU 6 into and from the laminator.

As the IGU 6 passes along the infeed conveyor table, its width is measured automatically using cameras, lasers or other of sensors; in simple machines this is done by the operator using a ruler or tape measure. This may also be achieved by side-guide rollers which are able to move laterally across the infeed conveyor table.

In one version, there are two sets of vertical sideguide rollers mounted on a moving frame, in length up to 8 ft to 10 ft long. Both frames come together in unison, around the centre line, until they touch both sides of the IGU 6, to position it at the centre line of the film reels 12, 14. The position of these sideguide rollers provides the information via encoders and or sensors to transmit the IGU width position.

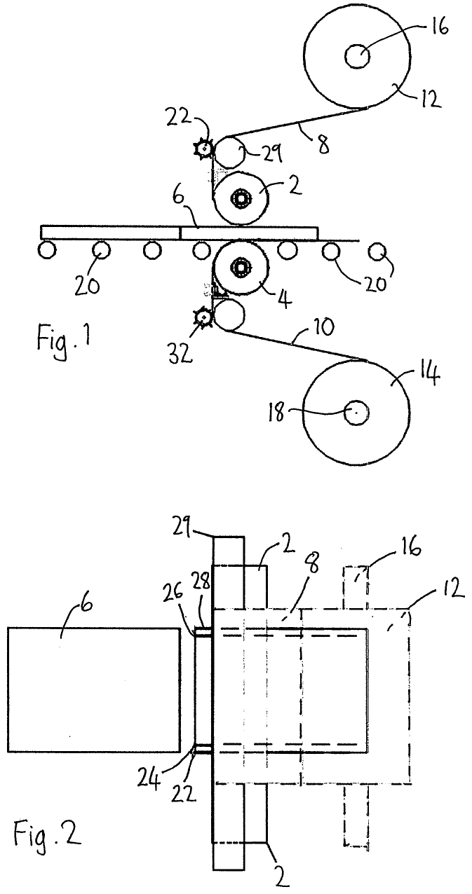

This information is sent directly to the perforating slitters 22, 24, 26, 28, shown in FIGS. 1 and 2, which are then driven by an electric motor to the required lateral/width position.

In some variations, the width data is manually input into a laminator control panel, based on many sources of information such as, a job card or computer bar code, or a tape measure system.

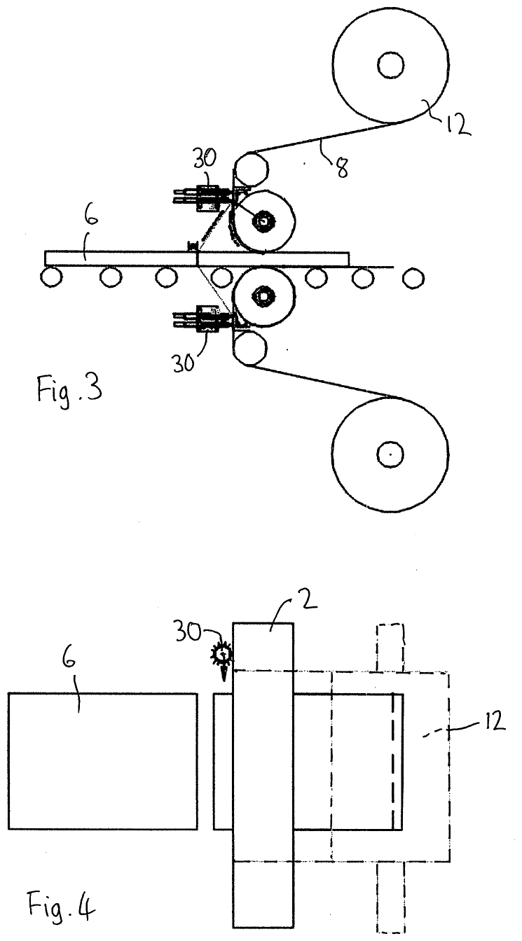

The lateral width slitters 30, shown in FIGS. 3 and 4, are comprised of a pneumatic pressure element, (a cylinder, or bellows), which applies the cutting pressure to a rotary blade whose circumference is slotted to create “teeth” typically 3.0 mm long with a 1.0 mm gap between them, all around the periphery. These perforate by crushing the film whilst it is passing over a hardened anvil bar or roller. These teeth crush cut the film, thereby creating the perforation pattern, which varies according to, the length of the teeth and the width of the gap between the teeth, (and thus the spacing of the teeth).

The perforators 22, 24, 26, 28 comprise toothed discs. To create the border, the perforators are arranged in pairs, a first pair of perforators 22, 24 and a second pair 26, 28. The distance between the two perforators in the pair is mechanically set and changed, by releasing a clamp and sliding each cutter towards or away from each other, along a slideway such as a carrier bar/track. This adjustment is used to set the width of the border/margin, along the length dimension of the IGU 6. Whilst the perforators 22, 24, 26, 28 are extended, they perforate the film 8 as it runs between the perforators and an anvil roller 29. Similarly, further perforators 32 (only one shown) perforate the lower film 10.

For the automated version, these perforators are mounted on a slideway with electric motors and belt or leadscrew drive, which can rapidly adjust their position on receipt of new width information from the control system.

The border across the width of the IGU is created by the lateral or cross perforating slitters 30, in a similar way these are mounted in pairs.

The lateral slitters 30 create the perforations at the leading end and the trailing end of the IGU 8. The IGU is stopped during its transit through the laminator, and this position is governed by sensors and an encoder, which detect the leading end and trailing end of the IGU, thus arranging its position to match the slitters 30 on the films 8, 10 which will be applied to that particular point of the IGU as it passes through the nip rollers 2, 4.

In some variations the lateral perforations may be made by a straight blade with teeth similarly profiled and again applied by pneumatic or mechanical pressure. Alternative options to create these perforations include perforating by laser beam, ultrasonic blade, or hot knife of hot wire system.

According to the invention it is possible to provide any of a range of machines, from a simple laminator with manual adjustment of the perforators and manual separation of the consecutive IGUs as they pass out of the machine, to fully automated peforator adjustments and mechanical separation of the IGUs as they leave the machine.

With its swift one-pass cycle, the laminator of the invention saves production time, increases flexibility and reduces manufacturing costs. Even with a simple machine, an IGU can be filmed on both sides in about 30 seconds.

The finished product has all the advantages of a pre-cut border whilst providing 100% surface protection right up to the moment the frames are attached.

The ability to film a wide range of width using one reel width improves productivity by avoiding down time matching reel widths to IGU width. The offline perforations avoid knives or blades touching the glass surface.

The system can create perforated patterns in the film for the production of windows with decorative bars, known as muntin bars, or Georgian style windows, simply by multiplying the number of longitudinal perforators and cross cut cycles. This is not possible with known filming systems.

What is claimed is:

1. A laminator for applying a plastics film to an insulated glass unit, comprising:
a conveyor system for feeding an insulated glass unit through the laminator in a horizontal orientation;
a reel of plastics film from which plastics film is arranged to be unwound;
a perforator having a circular cross section, rotatable around an axis which is transverse to a direction of travel of the unwound plastics film, the perforator being arranged to create a longitudinal line of perforations in the film, extending in the direction of travel and at a location outside or in line with an edge of the insulated glass unit;
a transverse cutter arranged to create a transverse cut or line of perforations in the plastics film; and
a laminating roller, located downstream of the perforator and the transverse cutter and arranged to press the plastics film against a face of the insulated glass unit to adhere the plastics film thereto.

2. The laminator of claim 1, further including a second perforator arranged to create a second longitudinal line of perforations in the plastics film, at a location outside or in line with a second edge of the insulated glass unit.

3. The laminator of claim 1, further including third and fourth perforators for creating third and fourth longitudinal lines of perforations in the plastics film, at locations inside the edges of the insulated glass unit.

4. The laminator of claim 1, which is arranged, simultaneously with adhering of said plastics film to said face, to adhere a second plastics film to a second face of the insulated glass unit.

5. The laminator of claim 4, further including:
a second perforator arranged to create a second longitudinal line of perforations in the plastics film, at a location outside or in line with a second edge of the insulated glass unit;
third and fourth perforators for creating third and fourth longitudinal lines of perforations in the plastics film, at locations inside the edges of the insulated glass unit;
a second reel of plastics film for a second side of the insulated glass unit;
fifth, sixth, seventh and eighth perforators for creating longitudinal lines of perforations in the second plastics film;
a second transverse cutter arranged to create a transverse line of perforations in the second plastics film; and
a second laminating roller, located downstream of the fifth, sixth, seventh and eighth perforators and the transverse cutter and arranged to press the second plastics film against the second face of the insulated glass unit to adhere the second plastics film thereto.

6. The laminator of claim 2, wherein a distance between said perforator and said second perforator is adjustable.

7. The laminator of claim 6, including a sensor for sensing a width of the insulated glass unit, the distance between said perforator and said second perforator being adjustable depending said width.

8. The laminator of claim 1, including a sensor for sensing a length of the insulated glass unit, the transverse cutter being operable depending on said length.

9. A method of adhering a plastics film to an insulated glass unit, the method comprising:
conveying an insulated glass unit through a laminator in a horizontal orientation;
unwinding plastics film from a reel;
rotating a perforator having a circular cross section around an axis which is transverse to a direction of travel of the unwound plastics film, to create a longitudinal line of perforations in the film, extending in the direction of travel and at a location outside or in line with an edge of the insulated glass unit;
operating a transverse cutter to create a transverse cut or line of perforations in the plastics film; and
causing a laminating roller to press the plastics film against a face of the insulated glass unit to adhere the plastics film thereto.

10. The method of claim 9, including operating a second perforator to create a second longitudinal line of perforations in the plastics film, at a location outside or in line with a second edge of the insulated glass unit.

11. The method of claim 10, including operating third and fourth perforators to create third and fourth longitudinal lines of perforations in the plastics film, at locations inside the edges of the insulated glass unit.

12. The method of claim 9, including, simultaneously with adhering of said plastics film to said face, adhering a second plastics film to a second face of the insulated glass unit.

13. The method of claim 11, including operating additional perforators to create additional longitudinal lines of perforations in the plastics film, at locations corresponding to the future positions of edges of at least one muntin bar.

14. The method of claim 13, including operating the transverse cutter to form additional transverse lines of perforations in the plastics film, at locations corresponding to the future positions of edges of at least one further muntin bar extending perpendicular to said at least one muntin bar.
